(19) United States
(12) Patent Application Publication
(10) Pub. No.: US 2011/0221753 A1
(43) Pub. Date: Sep. 15, 2011

(54) IMAGE DISPLAY APPARATUS AND IMAGE DISPLAY METHOD

(75) Inventor: Shinichi TSUKAGOSHI, Azumino-shi (JP)

(73) Assignee: SEIKO EPSON CORPORATION, Tokyo (JP)

(21) Appl. No.: 13/040,573

(22) Filed: Mar. 4, 2011

(30) Foreign Application Priority Data
Mar. 9, 2010 (JP) 2010-051892

(51) Int. Cl. G06T 17/00

(52) U.S. Cl. 345/428

(57) ABSTRACT

An image display apparatus includes: an image expanding unit which forms an expanded image of an input image; a super-resolution processing unit which performs super-resolution processing for the expanded image formed by the image expanding unit to produce a sharpened image; a display image forming unit which performs image deformation processing including change of the number of pixels on an image area as a display target within the sharpened image to produce a display image; a display unit which displays the display image produced by the display image forming unit; an input unit which receives input of a setting associated with image processing; and a control unit, wherein the control unit changes the degree of the image deformation processing according to the setting, and changes the degree of the sharpness of the super-resolution processing according to the degree of the image deformation processing.

### CROSS-REFERENCE

The present application claims priority from Japanese Patent Application No. 2010-051892 filed on Mar. 9, 2010, which is hereby incorporated by reference in its entirety.

### BACKGROUND

A typical type of image display apparatus such as a projector forms an expanded image by interpolating pixels into an image inputted from the outside, and displays the expanded image (Japanese Patent Publication No. 2008-298948, No. 2000-339450, and No. 8-336046). Generally, when pixels are interpolated for expansion of the image, the change of the colors of the pixels forming the contour within the expanded image becomes gradual change between the pixels. As a result, the sharpness of the expanded image becomes lower than that of the original image prior to expansion. For preventing lowering of the sharpness caused by image expansion, such an image display apparatus capable of performing so-called super-resolution processing has been developed. This processing detects the contour part where the color gradually changes within the expanded image, and selectively executes sharpening process for the detected part.

According to this type of the image display apparatus, image processing including image expansion (interpolation of pixels) and image contraction (number reduction of pixels) is further performed for the image obtained after the super-resolution processing in some cases before producing a display image. When the process for interpolating pixels into the image obtained after the super-resolution processing is executed, there is a possibility that the sharpness of the image again lowers. On the other hand, when the process for reducing the number of pixels on the image obtained after the super-resolution processing is executed, there is a possibility that the image quality deteriorates due to the loss of image information. Accordingly, the effect of improvement of the image quality achieved by the super-resolution processing performed prior to the image processing may decrease depending on the type of the image processing executed after the super-resolution processing.

### SUMMARY

Various embodiments may provide a technology which prevents lowering of the image quality of a display image obtained after super-resolution processing.

### Application Example 1

According to at least one embodiment of the disclosure, there is provided an image display apparatus which includes: an image expanding unit which forms an expanded image of an input image; a super-resolution processing unit which performs super-resolution processing for the expanded image formed by the image expanding unit to produce a sharpened image; a display image forming unit which performs image deformation processing including change of the number of pixels on an image area as a display target within the sharpened image produced by the super-resolution processing unit to produce a display image; a display unit which displays the display image produced by the display image forming unit; an input unit which receives input of a setting associated with image processing; and a control unit which controls the super-resolution processing unit and the display image forming unit. The control unit changes the degree of the image deformation processing performed by the display image forming unit according to the setting, and changes the degree of the sharpness of the super-resolution processing performed by the super-resolution processing unit according to the degree of the image deformation processing.

According to the image display apparatus having this structure, the degree of the super-resolution processing performed prior to the image deformation processing is controlled in accordance with the degree of the image deformation processing. More specifically, when it is expected that the effect of the super-resolution processing is decreased by interpolation of pixels performed in the image deformation processing, the level of the super-resolution processing is increased beforehand so as to avoid lowering of the sharpness of the display image. Also, when it is expected that the image quality of the image obtained after the super-resolution processing is deteriorated by removal of the pixels forming the display image at the time of the image deformation processing, the level of the super-resolution processing is decreased beforehand so as to reduce the possibility of the deterioration of the image quality caused by removal of the pixels.

### Application Example 2

According to at least one embodiment of the disclosure, there is provided the image display apparatus of the application example 1, wherein the image deformation processing includes over-scan processing which cuts the image area as the display target within the sharpened image, and expands the cut image area to a predetermined display size; the setting includes a first setting indicating the degree of expansion of the over-scan processing; and the control unit increases the degree of sharpness achieved by the super-resolution processing unit more greatly when the first setting is set at a high value than when the first setting is set at a low value.

According to the image display apparatus having this structure, the level of the super-resolution processing is increased in accordance with the varied degree of expansion even when the degree of expansion of the image in the over-scan processing is varied. Thus, decrease in the sharpness of the display image is avoided.

### Application Example 3

According to at least one embodiment of the disclosure, there is provided the image display apparatus of the application example 2, wherein the image deformation processing includes keystone correction processing which deforms the cut image obtained after the over-scan processing such that reduction on the upper side of the cut image increases in the upward direction or reduction on the lower side of the cut image increases in the downward direction; the setting includes a second setting indicating the degree of reduction of the keystone correction processing; and the control unit increases the degree of the super-resolution processing more greatly when the first setting is set at a high value than when the first setting is set at a low value, and decreases the degree of the super-resolution processing more greatly when the second setting is set at a high value than when the second setting is set at a low value.

According to the image display apparatus having this structure, the level of the super-resolution processing for the image can be controlled in advance such that deterioration of the image quality caused by the over-scan processing or the keystone correction can be prevented. Thus, lowering of the image quality of the display image obtained after the super-resolution processing can be avoided.

### Application Example 4

According to at least one embodiment of the disclosure, there is provided the image display apparatus of the application example 1, wherein the image deformation processing includes keystone correction processing which deforms the image area as the display target within the sharpened image such that reduction on the upper side of the image area increases in the upward direction or reduction on the lower side of the image area in the downward direction; the setting includes a second setting indicating the degree of reduction of the keystone correction processing; and the control unit decreases the degree of the super-resolution processing more greatly when the second setting is set at a high value than when the second setting is set at a low value.

According to the image display apparatus having this structure, the level of the super-resolution processing for the image can be controlled in advance such that deterioration of the image quality caused by the keystone correction can be prevented. Thus, lowering of the image quality of the display image obtained after the super-resolution processing can be avoided.

### Application Example 5

According to at least one embodiment of the disclosure, there is provided an image display method performed by an image display apparatus which includes: (a) allowing the image display apparatus to receive input of a setting associated with image processing; (b) allowing the image display apparatus to form an expanded image of an input image by expanding the input image; (c) allowing the image display apparatus to execute super-resolution processing for the expanded image and produce a sharpened image; (d) allowing the image display apparatus to execute image deformation processing including change of the number of pixels on an image area as a display target within the sharpened image at a degree of processing corresponding to the setting and produce a display image; and (e) allowing the image display apparatus to display the display image. In this case, (c) includes allowing the image display apparatus to change the degree of the super-resolution processing according to the degree of the image deformation processing indicated by the setting before execution of the super-resolution processing.

The invention can be practiced in various forms such as an image display apparatus or its control method, a computer program under which the functions of the image display apparatus or its control method are provided, and a recording medium recording the computer program.

### BRIEF DESCRIPTION OF THE DRAWINGS

Non-limiting and non-exhaustive embodiments of the present disclosure will be described with reference to the accompanying drawings, wherein like reference numbers reference like elements.

FIG. 1 is a block diagram showing the structure of an image display apparatus according to a first embodiment.

FIG. 2 is a flowchart showing the outline of super-resolution processing performed by a super-resolution processing unit.

FIGS. 3A and 3B show an example of the super-resolution processing performed by the super-resolution processing unit.

FIGS. 4A and 4B illustrate over-scan processing performed by an over-scan executing section of a display image forming unit.

FIGS. 5A and 5B illustrate an example of a table used when an internal setting of a super-resolution processing level is determined.

FIG. 6 is a block diagram showing the structure of an image display apparatus according to a second embodiment.

FIG. 7 schematically illustrates keystone correction performed by a keystone correcting section.

FIGS. 8A and 8B illustrate an example of a table used when a control unit in the image display apparatus according to the second embodiment determines an internal setting of a super-resolution processing level.

### DESCRIPTION OF EXEMPLARY EMBODIMENTS

Exemplary embodiments according to the invention are hereinafter described in the following order.

A. First Embodiment:

B. Second Embodiment:

C. Modified Examples:

### A. FIRST EMBODIMENT

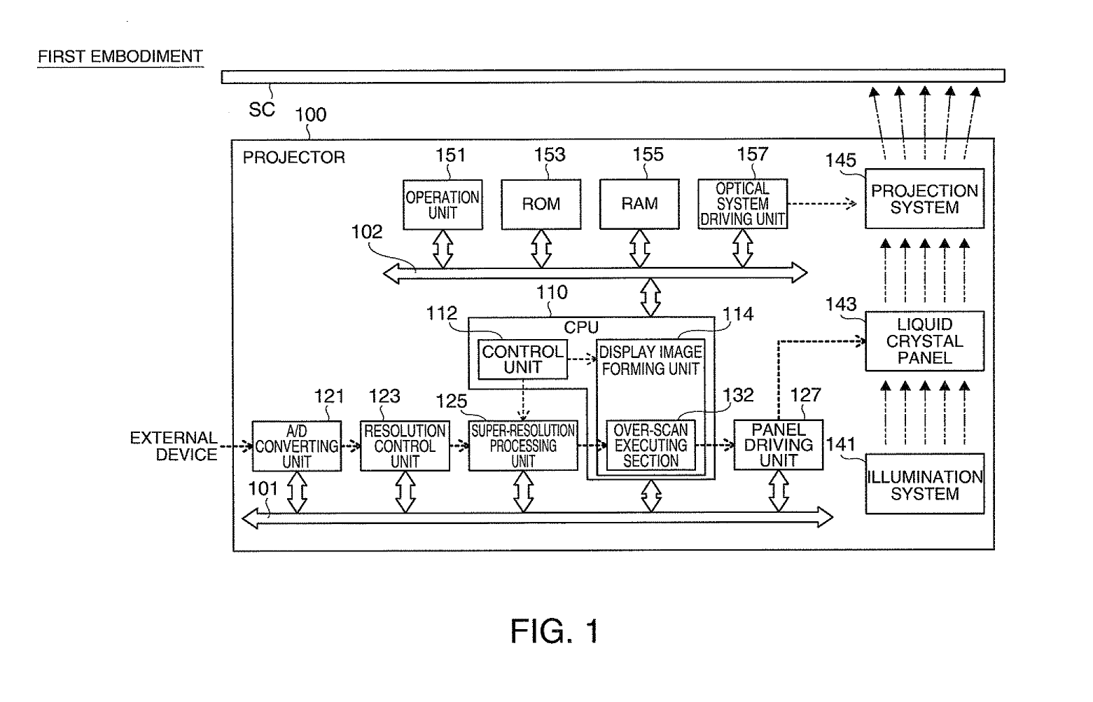

FIG. 1 is a block diagram showing the structure of an image display apparatus according to an embodiment of the invention. An image display apparatus 100 is a projector which forms images according to image signals inputted from an external device and projects the images onto a projection screen SC for image display thereon. The image display apparatus 100 includes an image signal processing system for processing image signals. The image signal processing system of the image display apparatus 100 has a central processing unit (CPU) 110, an A/D converting unit 121, a resolution control unit 123, a super-resolution processing unit 125, and a panel driving unit 127. The respective components of the image signal processing system are connected with one another via an internal bus 101. Each of the components included in the image signal processing system may contain a memory (not shown) dedicated for performing various types of image processes.

The image display apparatus 100 further includes an image projection system which forms projection images based on the image signals processed by the image signal processing system. The image projection system of the image display apparatus 100 has an illumination system 141, a liquid crystal panel 143, and a projection system 145. The image display apparatus 100 further includes a control system which controls the overall parts of the apparatus. The control system of the image display apparatus 100 has the CPU 110 contained in the image signal processing system as well, an operation unit 151, a ROM (read only memory) 153, a RAM (random access memory) 155, and an optical system driving unit 157. The respective units of the control system are connected with one another via an internal bus 102.

The CPU 110 which executes various programs stored in the ROM 153 after readout and expansion to the RAM 155 functions both as a control unit 112 and as a display image forming unit 114. The control unit 112 receives operation from a user through the operation unit 151, and controls the respective components of the image display apparatus 100 in correspondence with the operation received from the user. The control unit 112 controls transmission and reception of signals within the image display apparatus 100 such as supervision of synchronous signals for the A/D converting unit 121. The display image forming unit 114 performs image processing for producing final display images. In this embodiment, the display image forming unit 114 has an over-scan executing section 132 which executes over-scan processing (described later) for inputted images.

The image signal processing system processes image signals in the following manner. The A/D converting unit 121 receives input of an analog image signal supplied from an external device connected via a terminal such as a video input terminal (not shown), converts the received analog image signal into a digital signal, and transmits the digital signal to the resolution control unit 123. The resolution control unit 123 adjusts the resolution of an input image corresponding to the image signal received from the A/D converting unit 121 to the display resolution of the liquid crystal panel 143, and outputs the adjusted image. More specifically, the resolution control unit 123 interpolates pixels into the input image to increase the resolution of the input image, and transmits the resultant input image to the super-resolution processing unit 125. The super-resolution processing unit 125 executes super-resolution processing (described later) for the input image, and transmits the processed image to the CPU 110.

The over-scan executing section 132 of the display image forming unit 114 in the CPU 110 executes over-scan processing (described later) for the input image to produce a display image. The display image forming unit 114 transmits an image signal corresponding to the display image to the panel driving unit 127. The panel driving unit 127 drives the liquid crystal panel 143 based on the received signal.

The image projection system forms a projection image onto the projection screen SC in the following manner. The illumination system 141 supplies illumination light toward the panel surface of the liquid crystal panel 143. The supplied illumination light is modulated by the panel surface of the liquid crystal panel 143 while passing through the liquid crystal panel 143. The projection system 145 having a zoom lens and a focus lens expands the illumination light modulated by the liquid crystal panel 143 (referred to as “image light” as well) and projects the image light onto the projection screen SC.

The zoom lens and the focus lens of the projection system 145 are driven by the optical system driving unit 157 under the control of the control unit 112.

The operation unit 151 of the control system has buttons, a touch panel, and a remote controller. The control unit 112 receives the settings associated with the processes performed by the super-resolution processing unit 125 and the display image forming unit 114 from the operation unit 151. The specific settings for the processes will be described later.

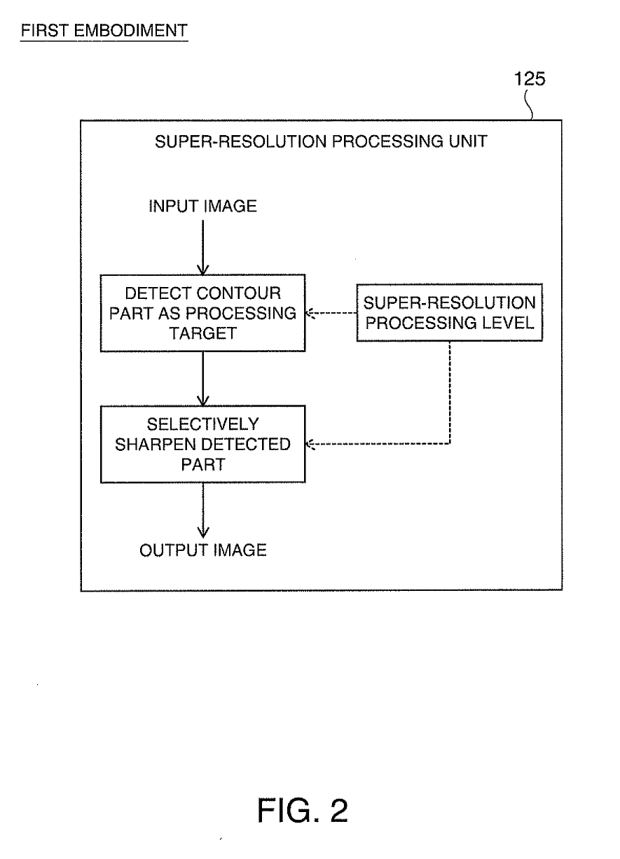

FIG. 2 is a flowchart showing the outline of the super-resolution processing performed by the super-resolution processing unit 125. The super-resolution processing unit 125 detects a line of pixels constituting the contour part where the color gradually changes between the pixels from the input image expanded by the resolution control unit 123, and selectively sharpens the detected contour part. In this specification, a series of these processes are referred to as “super-resolution processing”. This super-resolution processing allows the contour part on the input image to be more conspicuous and improves the sharpness of the entire input image while avoiding deterioration of the image quality of the part other than the contour forming part on the input image.

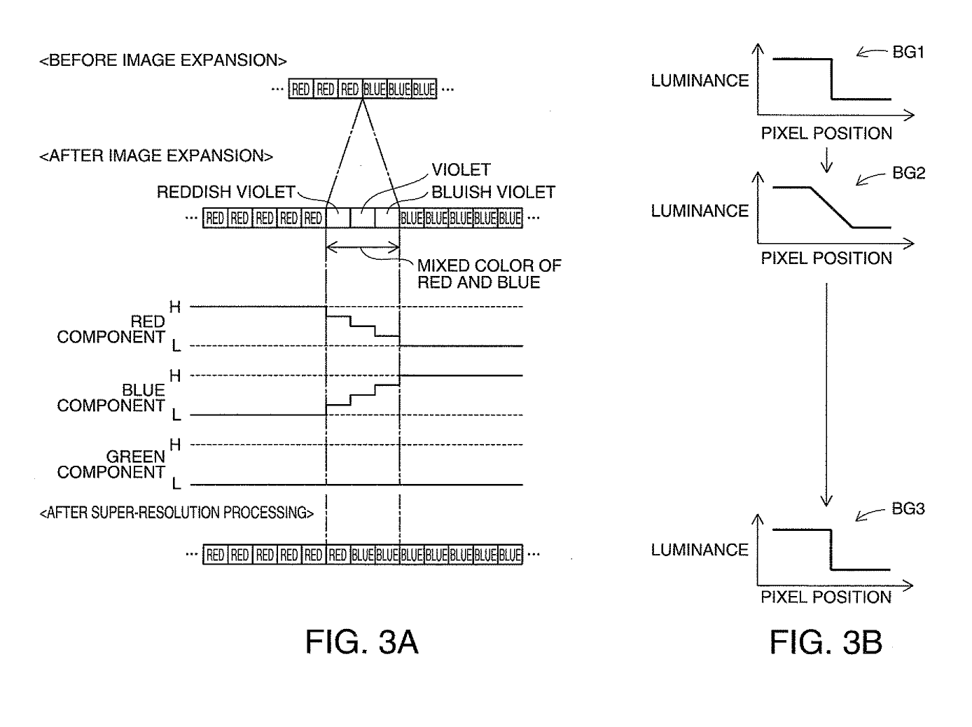

FIGS. 3A and 3B show an example of the super-resolution processing performed by the super-resolution processing unit 125. FIG. 3A schematically illustrates an example of the pixel line forming the contour part within the image, showing steps of the change of the pixel line achieved by the expansion processing by using the resolution control unit 123 and the super-resolution processing by using the super-resolution processing unit 125. FIG. 3B shows graphs BG1 through BG3 schematically illustrating the change of the luminance of the pixel line shown in FIG. 3A according to the pixel position in correspondence with the respective conditions of the pixel line shown in FIG. 3A.

It is assumed that the pixel line forming the contour part on the input image supplied to the resolution control unit 123 is a line of pixels constituted by continuous plural red pixels and continuous plural blue pixels (FIG. 3A). According to the pixel line forming the contour part, the luminance is kept constant at a relatively high value in the region of the continuous red pixels, lowers at the boundary between the red pixels and the blue pixels almost perpendicularly (graph BG1 in FIG. 3B), and is kept constant at the low value reached at the boundary in the region of the continuous blue pixels.

The image expansion processing performed by the resolution control unit 123 interpolates new pixels between the respective pixels on the input image. In this embodiment, a plurality of pixels in mixed colors of red and blue containing violet are interpolated between the continuous plural red pixels and the continuous plural blue pixels such that the color gradually changes from red to blue. FIG. 3A separately shows the respective color components (red, blue and green) on the pixel line obtained after the expansion processing. According to the respective color components on the pixel line interpolated at the boundary between the red pixels and the blue pixels, the red component decreases with steps in accordance with shift of the pixel position, while the blue component increases with steps in accordance with shift the pixel position.

By the effect of the interpolation of the mixed color pixels in the expansion processing, the change of the luminance on the boundary area between the red pixels and the blue pixels on the pixel line in accordance with shift of the pixel position after the expansion processing exhibits a more gradual slope than the corresponding change before the expansion processing (FIG. 3B). This condition produces gradual change of the color on the contour part, and thus lowers the sharpness of the entire image.

Therefore, the super-resolution processing unit 125 detects the contour part where the color gradually changes within the expanded image, and selectively sharpens the corresponding part by re-constructing the color constitution of the interpolated pixels such that the change of the luminance on the corresponding part becomes close to the change of the luminance before the expansion processing. More specifically, the super-resolution processing unit 125 detects from the input image such a part where the same color continues for a predetermined number of pixels and then gradually changes to another color on the subsequent pixel line, which changed color continues for a predetermined number of pixels. Then, the super-resolution processing unit 125 re-constructs the colors of the respective pixels forming the section of the detected part where the colors gradually change in accordance with color information of the pixel lines continuing from both sides of the corresponding section. By this re-construction, the change of the luminance on the corresponding section according to the pixel position becomes sharp (graph BG3).

Therefore, the super-resolution processing can be considered as a process for approximating the color construction of the pixel line forming the contour part on the image after the expansion processing to the color construction of the pixel line forming the contour part on the image prior to the expansion processing. In addition, the super-resolution processing can be considered as a process for approximating the change of the luminance of the pixel line forming the contour part on the image after the expansion processing according to the pixel position to the change of the luminance of the pixel line forming the contour part on the image prior to the expansion processing according to the pixel position.

According the image display apparatus 100 in this embodiment, the user can set the degree of the process in the super-resolution processing (the scale which indicates the level of the super-resolution processing and is hereinafter referred to as “super-resolution processing level”) by using the operation unit 151. More specifically, the user can select a level from four levels of level 0 through level 3 as a setting of the super-resolution processing level, and set the selected level. The level 0 corresponds to invalidation (OFF) of the super-resolution processing, and the degree of the process increases as the level becomes higher in the range from the level 1 to the level 3. The super-resolution processing level is increased or decreased by changing a threshold as a requirement for detecting the contour part to be sharpened, or varying the condition values used for re-constructing the colors of the pixels forming the detected part. According to this embodiment, the image display apparatus 100 has settings determined beforehand as specified values concerning the super-resolution processing levels (hereinafter referred to as “internal settings”) as well as the settings associated with the super-resolution processing levels set by the user. The details of the internal settings will be described later.

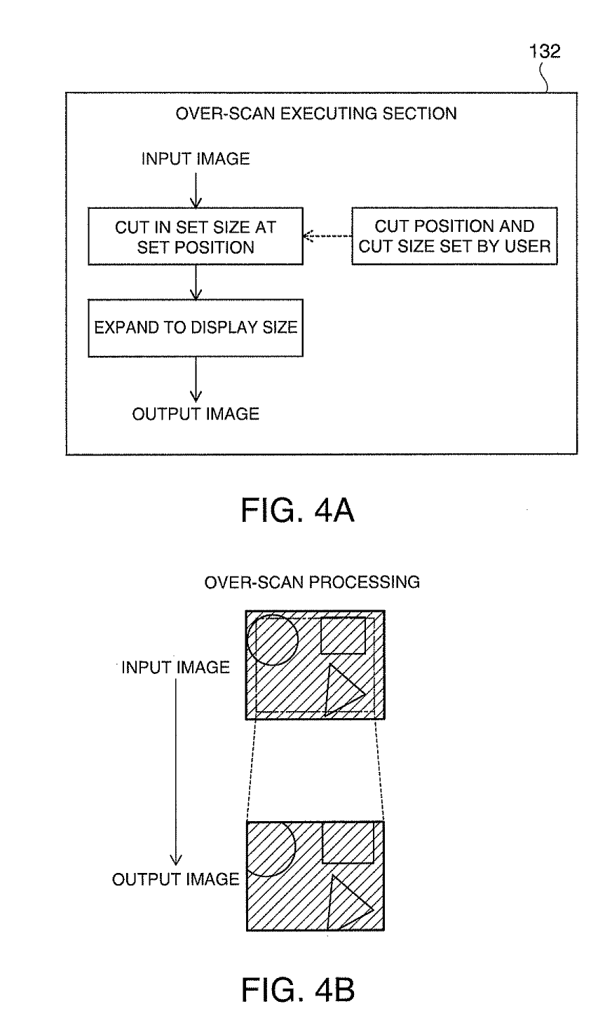

FIGS. 4A and 4B illustrate the over-scan processing performed by the over-scan executing section 132 of the display image forming unit 114. FIG. 4A is a flowchart showing the outline of the over-scan processing, and FIG. 4B schematically shows the change from the input image to the output image achieved by the over-scan executing section 132. The over-scan executing section 132 cuts an image area (indicated by a broken line in FIG. 4B) located at a predetermined position and having a predetermined size (approximately 90% of the original image size) from the input image, and expands the cut image to an image in the same size as that of the display image again. By this method, the image display apparatus 100 in this embodiment can remove the outer peripheral area of the image where distortion and image quality deterioration are easily produced by executing the over-scan processing prior to display.

The cutting position and the cutting size of the image for the over-scan processing can be determined by the user in advance by using the operation unit 151. Particularly, according to the image display apparatus 100 in this embodiment, the user can select the cutting size of the image for the over-scan processing from plural sizes established beforehand and set the selected size. In the over-scan processing, the degree of expansion of the cut image is determined according to the selected cutting size of the image. In this specification, the setting of the cutting size of the image selected by the user is referred to as “over-scan processing level”.

The user can select the over-scan processing level from five levels of “0”, “2”, “4”, “6”, and “8”. The setting “0” of the over-scan processing level corresponds to invalidation of the function of the over-scan executing section 132, which allows the image inputted from the outside to be displayed without trimming. In case of the settings of the other over-scan processing levels, the cutting size of the image becomes smaller as the setting level increases, raising the ratio of expansion of the output image from the input image in accordance with the setting level increase.

In the expansion processing, the over-scan executing section 132 interpolates pixels into the image obtained after the super-resolution processing. In this case, the possibility of lowering of the sharpness in the output image increases as the selected over-scan processing level performed by the over-scan executing section 132 rises. According to the image display apparatus 100 in this embodiment, therefore, the control unit 112 controls the super-resolution processing performed by the super-resolution processing unit 125 in the following manner to prevent decrease in the sharpness of the display image outputted from the over-scan executing section 132.

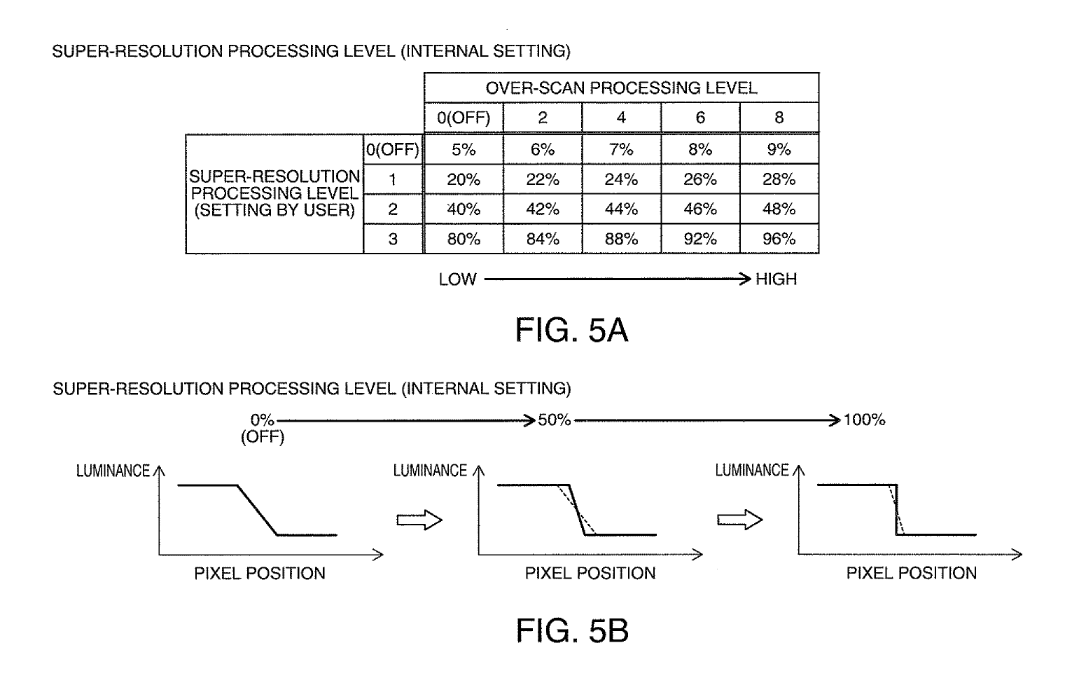

FIG. 5A shows an example of a table used for determining the internal setting of the super-resolution processing level. As explained above, the control unit 112 of the image display apparatus 100 in this embodiment receives both the setting operations associated with the super-resolution processing level and the over-scan processing level from the user. In this case, the control unit 112 determines the actual super-resolution processing level (internal setting) based on not only the setting of the super-resolution processing set by the user but also the over-scan processing level for the control of the super-resolution processing. More specifically, the control unit 112 determines the internal setting of the super-resolution processing level by using the table established beforehand as shown in FIG. 5A.

According to the table shown in FIG. 5A, the internal setting of the super-resolution processing level gradually increases as the setting of the super-resolution processing set the user rises. In addition, as can be seen from the table shown in FIG. 5A, the internal setting of the super-resolution processing level gradually increases as the setting of the over-scan processing level rises even at the same setting of the super-resolution processing level set by the user.

According to the table shown in FIG. 5A, the internal settings are determined such that the function of the super-resolution processing unit 125 is not invalidated even when the setting of the super-resolution processing level set by the user is “0” but performs the minimum level super-resolution processing. By these settings, the user can constantly observe a display image having higher image quality than that of the original image transmitted from the external device.

FIG. 5B illustrates the degree of the super-resolution processing in accordance with the internal setting of the super-resolution processing level. FIG. 5B shows graphs indicating the change of luminance according to the pixel position similar to the graphs shown in FIG. 3B in correspondence with the number line representing the internal settings. Broken lines in the graphs corresponding to the super-resolution processing level of 50% changed from 0% and the super-resolution processing level of 100% changed from 50% indicate graphs prior to the respective changes. The super-resolution processing unit 125 performs the sharpening process in such a manner that the change of luminance on the pixel line forming the detected contour part comes closer to perpendicular as the internal setting of the super-resolution processing level increases.

According to this embodiment, the image display apparatus 100 increases the super-resolution processing level as the setting of the over-scan processing level rises even at the same setting of the super-resolution processing level set by the user. Thus, decrease in the sharpness of the display image caused by the process of the over-scan executing section 132 can be avoided even when the user increases the setting of the over-scan processing level.

### B. SECOND EMBODIMENT

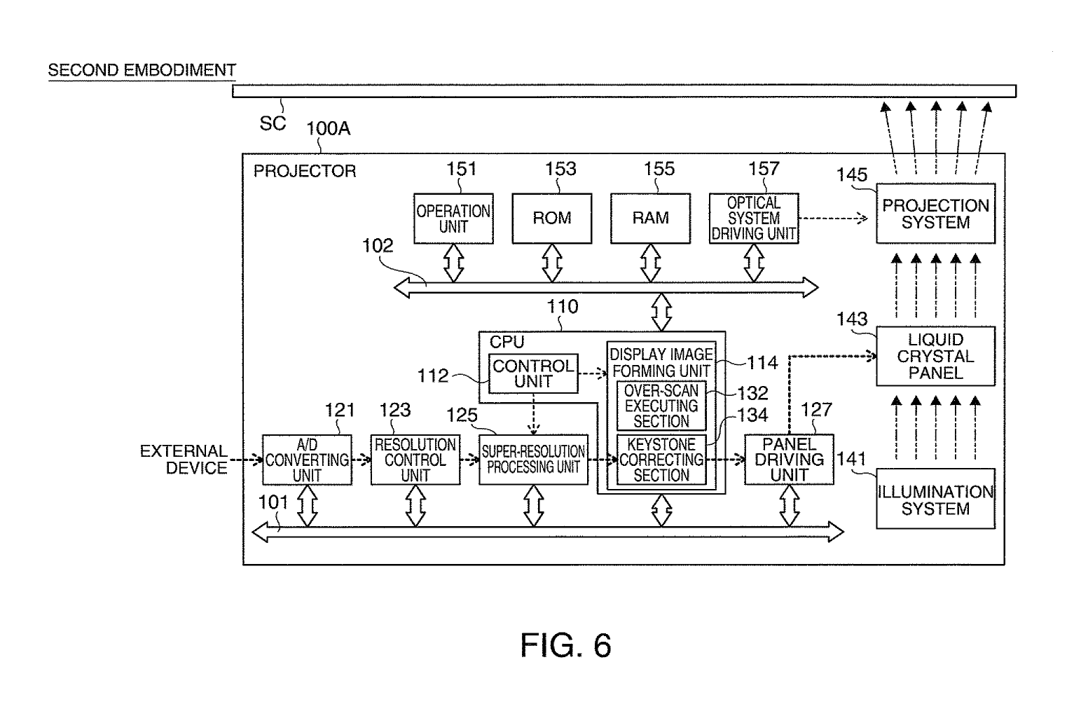

FIG. 6 is a block diagram showing the structure of an image display apparatus 100A according to a second embodiment of the invention. The structure shown in FIG. 6 is substantially similar to the structure shown in FIG. 1 except that a keystone correcting section 134 is provided on a display image forming unit 114A. According to the image display apparatus 100A in the second embodiment, the over-scan executing section 132 performs the over-scan processing for the image obtained after the super-resolution processing performed by the super-resolution processing unit 125, and the keystone correcting section 134 performs keystone correction for the image received from the over-scan executing section 132.

The control unit 112 receives the setting associated with the correction level of the image to be performed by the keystone correcting section 134 (hereinafter referred to as “keystone correction level”) from the operation unit 151. More specifically, the user can select the keystone correction level to be performed by the keystone correcting section 134 from five levels of “level 0”, “level 2”, “level 4”, “level 6”, and “level 8” and set the selected level. The keystone correcting section 134 performs the keystone correction for the input image in accordance with the selected keystone correction level.

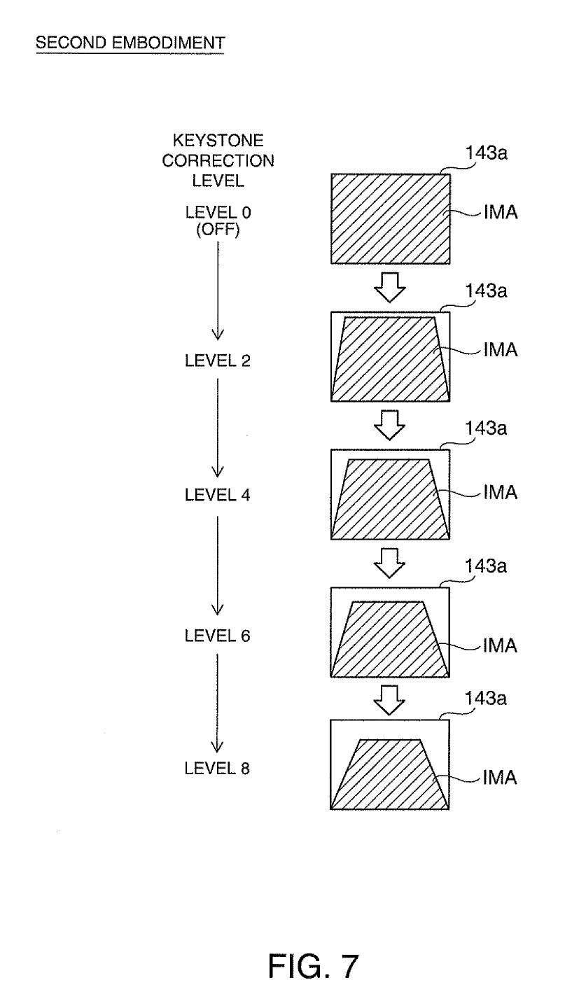

FIG. 7 schematically illustrates the keystone correction executed by the keystone correcting section 134. FIG. 7 shows a panel surface 143a of the liquid crystal panel 143 for each setting of the keystone correction levels. The panel surface 143a for each correction level has a display image forming area IMA indicated by a hatched area in the figure as an area where the display image is formed. The area outside the display image forming area IMA on each of the panel surfaces 143a is displayed as a total black area. While FIG. 7 shows the keystone correction which deforms the display image forming area IMA such that reduction on the upper side of the area IMA increases in the upward direction, the keystone correction performed by the keystone correcting section 134 may deform the display image forming area IMA such that reduction on the lower side of the area IMA increases in the downward direction.

The keystone correcting section 134 executes the keystone correction which deforms the image area as the display target (the display image forming area IMA) such that reduction on the upper or lower side of the area IMA increases in the upward direction or downward direction on the screen. The degree of deformation of the image in the keystone correction increases as the setting of the keystone correction level rises. Thus, the height of the trapezoidal shape of the display image forming area IMA formed on the panel surface 143a of the liquid crystal panel 143 more largely decreases as the keystone correction level increases as illustrated in FIG. 7.

Generally, when image light is projected to the projection screen SC in the upward direction from below, the keystone correction is performed such that reduction on the upper side of the display image forming area IMA increases in the upward direction. On the other hand, when image light is projected to the projection screen SC in the downward direction from above, the keystone correction is performed such that reduction on the lower side of the display image forming area IMA increases in the downward direction. It is preferable that the keystone correction level is set at a higher level as the angle formed by the optical axis of the projection light projected from the projection system 145 of the image display apparatus 100A and the horizontal plane (plane perpendicular to the plane to which image light is projected) becomes larger.

For contraction deformation of the image, the pixels on the image are partially removed for reduction. In case of the keystone correction performed for the image obtained after the high-level super-resolution processing by using the super-resolution processing unit 125, it is highly possible that glare on the image increases in the high-level contraction area where a large number of pixels are removed. Thus, in case of the keystone correction performed after the super-resolution processing, there is a possibility that unexpected deterioration of the image quality occurs. According to the image display apparatus 100A in the second embodiment, however, the control unit 112 controls the super-resolution processing unit 125 and the display image forming unit 114A in the following manner to prevent deterioration of the image quality.

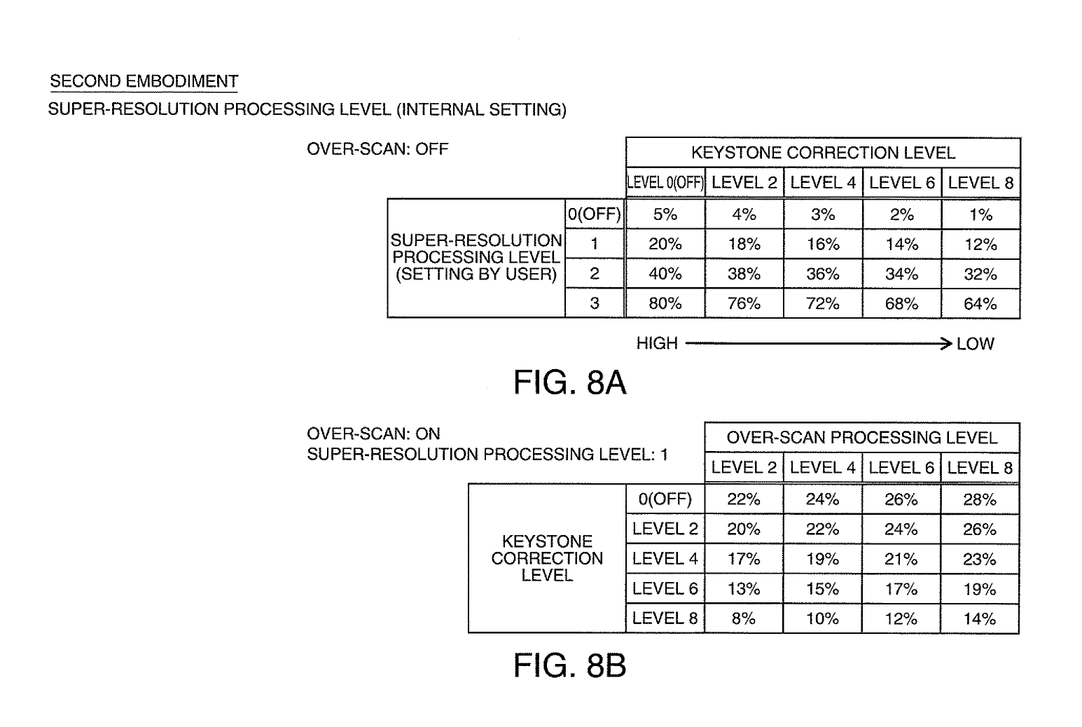

FIGS. 8A and 8B show an example of a table referred to by the control unit 112 of the image display apparatus 100A in the second embodiment for determining the internal setting of the super-resolution processing level. FIG. 8A corresponds to the table used when the function of the over-scan executing section 132 is invalidated. In case of invalidation of the function of the over-scan executing section 132, the process for expanding the image outputted from the super-resolution processing unit 125 is not executed, and the process for partially contracting the image is only performed by the keystone correcting section 134. In this case, the control unit 112 determines the internal setting of the super-resolution processing level based on both the setting of the super-resolution processing level set by the user, and the setting of the keystone correction level.

According to the table shown in FIG. 8A, the internal setting of the super-resolution processing level gradually increases as the setting of the super-resolution processing set by the user rises. In addition, as can be seen from the table shown in FIG. 8A, the internal setting of the super-resolution processing level gradually decreases as the setting of the keystone correction level rises even at the same setting of the super-resolution processing level set by the user. Thus, the image display apparatus 100A in the second embodiment decreases the degree of the super-resolution processing performed by the super-resolution processing unit 125 as the level of the keystone correction executed after the process by the super-resolution processing unit 125 rises.

By this control, the image display apparatus 100A prevents deterioration of the image quality caused by the keystone correction executed for the image after the super-resolution processing. As can be seen from the table shown in FIG. 8A, the internal settings are established such that the function of the super-resolution processing unit 125 is not invalidated but performs the minimum level super-resolution processing even when the setting of the super-resolution processing level set by the user is “0”. By this setting, the user can constantly observe a display image having higher image quality than that of the original image transmitted from the external device.

FIG. 8B shows the table used when the over-scan processing is performed by the over-scan executing section 132 under the condition in which the setting of the super-resolution processing level set by the user is set at level 1. In case of execution of the over-scan processing by the over-scan executing section 132, the process for expanding the image outputted from the super-resolution processing unit 125, and the image deformation process for partially contracting the expanded image are both performed. In this case, it is preferable that the internal setting of the super-resolution processing level is determined based on the setting of the super-resolution processing level set by the user, the setting of the over-scan processing level, and the setting of the keystone correction level.

According to the table shown in FIG. 8B, the internal setting of the super-resolution processing level decreases as the keystone correction level increases. In addition, as can be seen from the table shown in FIG. 5B, the internal setting of the super-resolution processing level increases as the setting of the over-scan processing level rises even at the same keystone correction level. The image display apparatus 100A has a table (not shown) similar to the table shown in FIG. 8B for each of the super-resolution processing levels (0 through 3) set by the user. These tables are determined such that the internal setting increases as the setting of the super resolution processing level set by the user rises.

According to the image display apparatus 100A in the second embodiment, the super-resolution processing level increases as the expansion rate of the image in the over-scan processing performed after the process of the super-resolution processing unit 125 rises similarly to the first embodiment. On the other hand, the super-resolution processing level decreases as the degree of contraction deformation of the image by the keystone correction increases. Thus, the image display apparatus 100A can appropriately control the degree of the super-resolution processing in accordance with the level of the image processing performed after the process of the super-resolution processing unit 125. Accordingly, lowering of the image quality of the display image obtained after the super-resolution processing can be avoided.

### C. MODIFIED EXAMPLES

The invention is not limited to the respective embodiments and examples described herein but may be practiced otherwise without departing from the scope and spirit of the invention. Therefore, various modifications including the following changes may be made.

### C1. Modified Example 1

In the respective embodiments, a part of the structure provided by hardware may be replaced with software, and a part of the structure provided by software may be replaced with hardware. Moreover, other processor having a part of the functions of the display image forming units 114 and 114A may be added, for example.

### C2. Modified Example 2

According to the respective embodiments, the super-resolution processing unit 125 detects the contour part to be sharpened by examining the color constitution of each pixel line within the image as the super-resolution processing. Then, the super-resolution processing unit 125 carries out the process for re-constructing the color constitution on the corresponding contour part such that this color constitution approaches the color constitution of the pixels forming the corresponding contour part prior to the expansion processing. However, the super-resolution processing unit 125 may perform the super-resolution processing by other methods. For example, the super-resolution processing may detect the difference between the image expanded and then contracted to the size before expansion and the input image before expansion, and repeatedly correct the expanded image until this difference becomes small.

### C3. Modified Example 3

According to the respective embodiments, the control unit 112 determines the internal setting of the super-resolution processing level by referring to the tables established beforehand (FIGS. 5A, 8A and 8B). However, the control unit 112 may determine the internal setting of the super-resolution processing level by using a map or a function prepared beforehand in place of the tables.

### C4. Modified Example 4

According to the second embodiment, the display image forming unit 114A includes both the over-scan executing section 132 and the keystone correcting section 134. However, the display image forming unit 114A is not required to have the over-scan executing section 132. In this case, the control unit 112 may decrease the super-resolution processing level as the degree of contraction of the image in the keystone correcting process increases in the similar manner.

### C5. Modified Example 5

According to the respective embodiments, the display image forming units 114 and 114A have the over-scan executing section 132 or both the over-scan executing section 132 and the keystone correcting unit 134. However, the display image forming units 114 and 114A may further have a section for executing other image deformation processing including change of the number of pixels. In this case, the super-resolution processing level performed by the super-resolution processing unit 125 may be changed according to the degree of the processing performed by the added section.

### C6. Modified Example 6

According to the respective embodiments, the image display apparatuses 100 and 100A are provided as projectors for projecting images on the projection screen SC for image display thereon. However, each of the image display apparatuses 100 and 100A may be an image display apparatus which displays images by using other display units. For example, each of the image display apparatuses 100 and 100A may be a liquid crystal display or a plasma display. Alternatively, each of the image display apparatuses 100 and 100A may be an apparatus which includes a digital micromirror device as a polarizing unit in place of the liquid crystal panel 143.

What is claimed is:

1. An image display apparatus comprising:
an image expanding unit which forms an expanded image of an input image;
a super-resolution processing unit which performs super-resolution processing for the expanded image formed by the image expanding unit to produce a sharpened image;
a display image forming unit which performs image deformation processing including change of the number of pixels on an image area as a display target within the sharpened image produced by the super-resolution processing unit to produce a display image;
a display unit which displays the display image produced by the display image forming unit;
an input unit which receives input of a setting associated with image processing; and
a control unit which controls the super-resolution processing unit and the display image forming unit,
wherein
the control unit changes the degree of the image deformation processing performed by the display image forming unit according to the setting, and changes the degree of the sharpness of the super-resolution processing performed by the super-resolution processing unit according to the degree of the image deformation processing.

2. The image display apparatus according to claim 1, wherein
the image deformation processing includes over-scan processing which cuts the image area as the display target within the sharpened image, and expands the cut image area to a predetermined display size;
the setting includes a first setting indicating the degree of expansion of the over-scan processing; and
the control unit increases the degree of sharpness achieved by the super-resolution processing unit more greatly when the first setting is set at a high value than when the first setting is set at a low value.

3. The image display apparatus according to claim 2, wherein
the image deformation processing includes keystone correction processing which deforms the cut image obtained after the over-scan processing such that reduction on the upper side of the cut image increases in the upward direction or reduction on the lower side of the cut image increases in the downward direction;
the setting includes a second setting indicating the degree of reduction of the keystone correction processing; and
the control unit increases the degree of the super-resolution processing more greatly when the first setting is set at a high value than when the first setting is set at a low value, and decreases the degree of the super-resolution processing more greatly when the second setting is set at a high value than when the second setting is set at a low value.

4. The image display apparatus according to claim 1, wherein
the image deformation processing includes keystone correction processing which deforms the image area as the display target within the sharpened image such that reduction on the upper side of the image area increases in the upward direction or reduction on the lower side of the image area in the downward direction;
the setting includes a second setting indicating the degree of reduction of the keystone correction processing; and
the control unit decreases the degree of the super-resolution processing more greatly when the second setting is set at a high value than when the second setting is set at a low value.

5. The image display apparatus according to claim 1, wherein
the image deformation processing includes keystone correction processing which deforms the cut image obtained after the over-scan processing such that reduction on the upper side of the cut image increases in the upward direction or reduction on the lower side of the cut image increases in the downward direction;
the setting includes a second setting indicating the degree of reduction of the keystone correction processing; and
the control unit decreases the degree of the super-resolution processing more greatly when the second setting is set at a high value than when the second setting is set at a low value.

6. The image display apparatus according to claim 1, wherein the control unit changes the degree of the super-resolution processing based on a table which determines the degree of the super-resolution processing according to the setting.

7. The image display apparatus according to claim 1, wherein the control unit changes the degree of the super-resolution processing based on a function which determines the degree of the super-resolution processing according to the setting.

8. An image display apparatus comprising:
a super-resolution processing unit which performs super-resolution processing for an input image at a predetermined degree to produce a sharpened image;
a display image forming unit which performs image deformation processing including change of the number of pixels on an image area as a display target within the sharpened image produced by the super-resolution processing unit to produce a display image;
a display unit which displays the display image produced by the display image forming unit;
an input unit which receives input of a setting associated with the image deformation processing; and
a control unit which controls the super-resolution processing unit and the display image forming unit,
wherein
the control unit changes the degree of the image deformation processing performed by the display image forming unit according to the setting, and changes the degree of the sharpness of the super-resolution processing performed by the super-resolution processing unit according to the setting.

9. An image display method performed by an image display apparatus, comprising:
(a) allowing the image display apparatus to receive input of a setting associated with image processing;
(b) allowing the image display apparatus to execute super-resolution processing for an input image at a predetermined degree and produce a sharpened image;
(c) allowing the image display apparatus to execute image deformation processing including change of the number of pixels on an image area as a display target within the sharpened image at a degree of processing corresponding to the setting and produce a display image; and
(d) allowing the image display apparatus to display the display image,
wherein (b) includes allowing the image display apparatus to change the predetermined degree of the super-resolution processing according to the degree of the image deformation processing indicated by the setting before execution of the super-resolution processing.
